(19) United States
(12) Patent Application Publication
(10) Pub. No.: US 2009/0092289 A1
(43) Pub. Date: Apr. 9, 2009

(54) Method for generating 3D building models from a set of floor plans

(76) Inventor: Jeffrey M. Rye, Minneapolis, MN (US)

Correspondence Address: Kris T. Frederick, Esq.;Patent Services, Honeywell International Inc., 101 Columbia Road, Morristown, NJ, 07962, US

(21) Appl. No.: 11/973,493

(22) Filed: Oct. 8, 2007

(51) Int. Cl. G06K 9/00

(52) U.S. Cl. 382/113

(57) ABSTRACT

A method and system of generating 3D models from a set of 2D floor plans using an algorithm to classify pixels from each floor plan as outside or inside. Inside pixels are drawn as horizontal rectangles and walls are drawn as vertical rectangles. When a floor is compared to the one below and the pixel below is interior and the pixel above is exterior, it is marked as a roof pixel.

### FIELD OF THE INVENTION

The present invention relates to rendering 3D drawings from floor models. More particularly, the present invention relates to a system which converts a plurality of floor plans for a building into a 3D version.

### BACKGROUND OF THE INVENTION

Techniques for rendering building models in 3D have been experimentally shown to improved the performance of firefighter and other first responder in making an initial assessment of a scene. The key factor in limiting the inclusion of 3D building models in commercial first response systems is the time required to commission a system involving a 3D model.

At the present time, 3D drawings of buildings are either hand drawn, such as by an architect or engineer, or are produced directly in a CAD (computer assisted drafting) program which requires a large amount of time and money. To date, no system has been proposed that uses simple data, such as the respective floor plans of a building or other structure, to translate directly into a 3D model.

Accordingly, one advantage of the present invention is to provide a system and method for producing 3D models of buildings for building owners to have on hand in the event of a fire or other emergency in order to orient first responders.

Another advantage of the present invention is to provide a simple system and method for producing 3D models directly from floor plans by approximating the actual building, including floors and roofs.

Other advantages will appear hereinafter.

### SUMMARY OF THE INVENTION

It has now been discovered that the above and other advantages of the present invention may be obtained in the following manner. In its simplest form, the present invention comprises a system and method for producing 3D models of buildings from floor plans using a conversion algorithm. The 3D model assists persons needing to enter the building to be quickly and accurately oriented as to the location of items on various floors.

The conversion algorithm works in three steps. The first step generates one presence map for each floor plan. The maps are electronic renditions that may be taken from other electronic files or from scanned paper or hard copy plans, or otherwise imported into the processor. The maps are two dimensional grids indicating which pixels are exterior to the building and which are interior. The second step determines which interior elements in the presence maps represent floor and which represent roof. The final step renders the building in 3D from the presence maps.

In the preferred embodiment, the algorithm of this invention begins populating the presence map by considering each pixel in the floor plan, although any pixel can be the first one considered. The algorithm considers neighbor pixels as being each pixel directly up, down, left and right of the pixel being examined. The algorithm is also valid when neighbors further include pixels located diagonally from the pixel being examined, but will treat pixels as outside when wall-lines are too narrow.

Each succeeding pixel is marked as being outside or inside until the entire quantity of pixels has been marked. For each pixel, the following procedure, called FillUnkown, is used. A pixel is selected, and the procedure returns to select the next pixel if the presence for the selected pixel is known. If it is not the outside color, it is marked as inside. If it is adjacent the edge of the image, it is marked as outside or if any pixel neighbor is outside, it is marked as outside. If all the neighbor pixels are inside, it is marked as inside. Any remaining unknown pixels are marked as inside.

Each floor of a structure is taken from a floor plan to a 2D rendition that is placed on top (when the bottom floor is rendered first) of the prior floor rendition. The preferred rendering approach draws a horizontal rectangle for each interior pixel in the presence map and a vertical rectangle for each wall in the presence map. A wall is defined by the edge between an interior pixel and an exterior pixel.

The roof of the structure is determined by masking each floor by the one above it. The top floor plan is considered to be the roof if each pixel of a floor plan is interior and the corresponding pixel from the floor plan above it is exterior. If it is also interior, it is marked as floor. If the pixel is marked as outside, it is unaffected by the masking.

### BRIEF DESCRIPTION OF THE DRAWINGS

For a more complete understanding of the invention, reference is hereby made to the drawings, wherein like numbers refer to like elements, and in which:

FIG. 1 is a plan view of a floor plan shown in 2D;

FIG. 2 is a 3D view of the floor shown in FIG. 1; and

FIG. 3 is a 3D view of a plurality of floor plans showing the total building.

### DETAILED DESCRIPTION OF THE PREFERRED EMBODIMENT

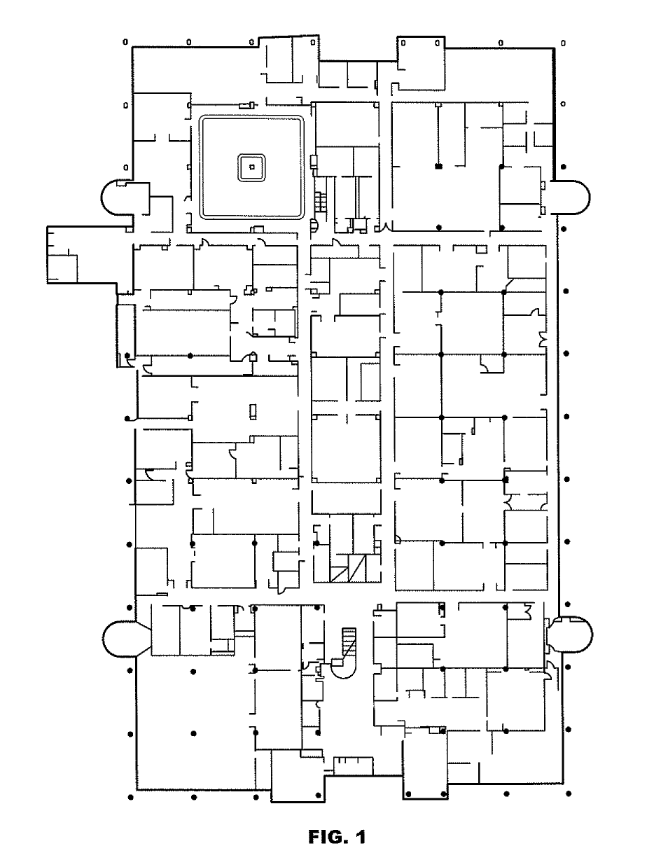

As shown in the drawings, this invention produces a 3D rendition of a building or other structure from 2D floor plans or other drawings. The floor plans, shown in FIG. 1 as a typical floor plan, has areas inside and outside the structure, with interior walls and exterior features such as a canopy over an entrance.

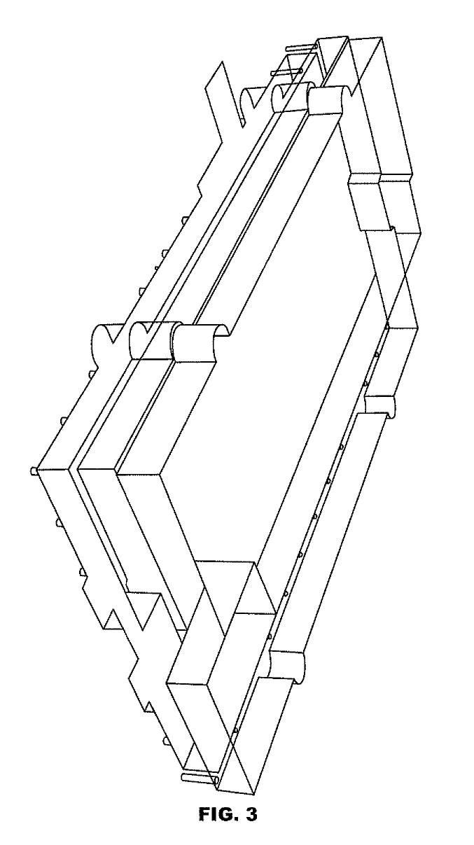

An electronic form of the floor plan in pixels is generated by a computer or processor, either by scanning hand drawings, using Computer Assisted Drafting programs or by other conventional methods of producing electronic renditions of a 2D figure or drawing. A presence map is generated for each floor plan, such that the maps are 2D grids indicating which pixels are exterior to the building and which are interior. Next the pixels are examined to determine which interior elements in the presence maps represent floor and which are roof. The presence maps for all the floors are combined by the computer into the resulting 3D model as shown in FIG. 3.

Each presence map is populated with pixels that represent space characterized as outside floor or roof. The 3D model is defined by a horizontal rectangle for each pixel in the presence map marked floor or roof and a vertical rectangle for each edge between floor and non-floor pixels.

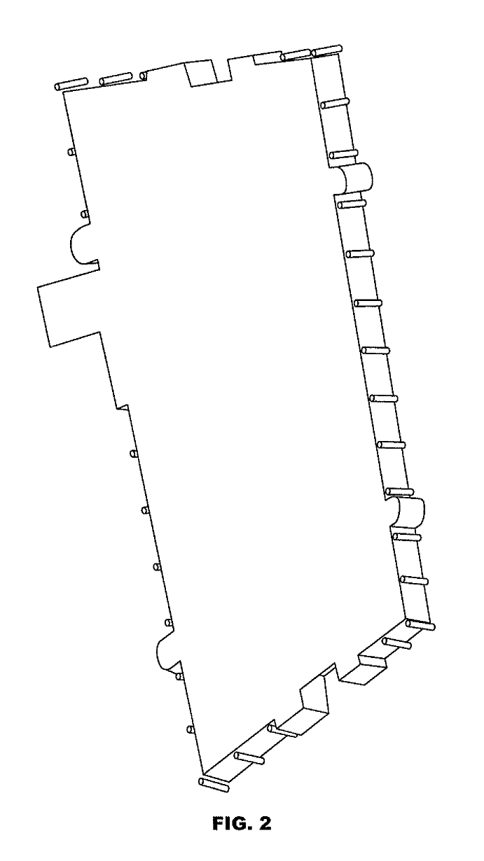

The algorithm used to generate the presence maps begins by selecting at least one pixel, preferably the pixel that is the most upper left pixel on the floor plan, and this is marked as outside. Alternatively, at least one more pixel may be marked as outside, such that the two or more pixels are marked using a different color for each. After starting with this at least one pixel, the algorithm proceeds to mark adjacent pixels in sequence, both up and down as well as those diagonally adjacent to the pixel being marked. If the presence is known to be outside (as the first one is) or inside, it is marked as such and the next pixel is examined. A pixel is known to be inside if its color is not one of the background colors. If all the neighbor pixels are outside, the pixel of interest is marked as outside. Similarly, if all the neighbor pixels are inside, this pixel is marked as floor. This applies to pixels only if the presence was not already known. When a pixel is adjacent to both an outside pixel and an inside pixel, it is marked as a wall. Inside pixels are then shown as a horizontal rectangle. Walls are defined as the edges between floor and non-floor pixels and are shown as a vertical rectangle. This generates the 3D view, such as shown in FIG. 2.

Some pixels will not be identified as either inside or outside at first. These unknown pixels are marked in several ways. If the pixel is not marked as outside, it may be marked as inside. If the pixel is adjacent to the edge of the image, it is marked as outside. If any neighbor pixel is outside, the unknown pixel is also marked as outside. If all the neighbor pixels are inside, mark this pixel as inside also. In addition, when the presence of a pixel is known, each of its neighbors are viewed as unknown and the process is repeated.

When all the floors have been rendered into presence maps, two adjacent floors are masked over one another. For each pixel of the floor plan, if it is interior and the corresponding pixel from the floor plan above is exterior, the pixel is marked as roof. Otherwise, if the upper pixel is interior, it is marked as floor. If the pixel is marked outside, it is unaffected by the masking.

While particular embodiments of the present invention have been illustrated and described, it is not intended to limit the invention, except as defined by the following claims.

1. A method of generating 3D building models of a structure from a set of floor plans, comprising the steps of:
presenting a plurality of floor plans of a structure in electronic form having pixels representing the lines of said floor plans;
marking pixels from each floor plan with its row and column indices;
starting with one pixel marked as outside and proceeding to adjacent pixels in sequence to all remaining pixels, using an algorithm wherein:
a) if the presence of the pixel is known, mark it and return to the next pixel;
b) and if the pixel is not outside, mark it as a wall pixel and return to the next pixel;
c) if the pixel is adjacent to the edge of the image, mark it as outside and return;
d) if any neighbor pixel is outside, mark this pixel as outside also;
e) if all of the neighbor pixels are inside, mark this pixel as floor; and
f) if the presence for this pixel is known, repeat steps a-e for each of its neighbors;
drawing inside pixels as horizontal rectangles and walls as vertical rectangles, wherein wall pixels are defined by the edge between an interior pixel and an exterior pixel, to present a presence map of a floor in 3D;
repeating the production of a presence map for all the floors in sequence; and
forming the resulting 3D presence maps as a 3D model of the structure.

2. The method of claim 1, wherein said one pixel marked as outside is the most upper left pixel on the floor plan and it is marked as outside.

3. The method of claim 1, which further includes at least one more pixel marked as outside, each of said marked pixels being a different color.

4. The method of claim 1, which includes the step of masking each floor pixel by the one above such that if the pixel below is interior and the pixel above is exterior, to mark it as a roof pixel.

5. A system for generating 3D building models of a structure from a set of floor plans, comprising:
a processor for presenting a plurality of floor plans of a structure in electronic form having pixels representing the lines of said floor plans;
said processor marking pixels from each floor plan with its row and column indices starting with one pixel marked as outside and proceeding to adjacent pixels in sequence to all remaining pixels, using an algorithm wherein
g) if the presence of the pixel is known, mark it and return to the next pixel;
h) and if the pixel is not outside, mark it as a wall pixel and return to the next pixel;
i) if the pixel is adjacent to the edge of the image, mark it as outside and return;
j) if any neighbor pixel is outside, mark this pixel as outside also;
k) if all of the neighbor pixels are inside, mark this pixel as floor; and
l) if the presence for this pixel is known, repeat steps a-e for each of its neighbors;
drawing inside pixels as horizontal rectangles and walls as vertical rectangles, wherein wall pixels are defined by the edge between an interior pixel and an exterior pixel, to produce presence map in 3D for each floor; and
forming the resulting 3D model from the presence maps.

6. The system of claim 5, wherein said one pixel marked as outside is the most upper left pixel on the floor plan and it is marked as outside.

7. The system of claim 5, which further includes at least one more pixel marked as outside, each of said marked pixels being a different color.

8. The system of claim 5, in which the processor masks each floor pixel by the one above such that the pixel below is interior and the pixel above is exterior, to mark it as a roof pixel.

9. A system for generating 3D building models of a structure from a set of floor plans, comprising:
processor means for presenting a plurality of floor plans of a structure in electronic form having pixels representing the lines of said floor plans;
said processor means marking pixels from each floor plan with its row and column indices starting with one pixel marked as outside and proceeding to adjacent pixels in sequence to all remaining pixels, using an algorithm wherein
m) if the presence of the pixel is known, mark it and return to the next pixel;
n) and if the pixel is not outside, mark it as a wall pixel and return to the next pixel;
o) if the pixel is adjacent to the edge of the image, mark it as outside and return;
p) if any neighbor pixel is outside, mark this pixel as outside also;
q) if all of the neighbor pixels are inside, mark this pixel as floor; and
r) if the presence for this pixel is known, repeat steps a-e for each of its neighbors;
drawing inside pixels as horizontal rectangles and walls as vertical rectangles, wherein wall pixels are defined by the edge between an interior pixel and an exterior pixel, to produce presence map in 3D for each floor; and
forming the resulting 3D model from the presence maps.

10. The system of claim 9, wherein said one pixel marked as outside is the most upper left pixel on the floor plan and it is marked as outside.

11. The system of claim 9, which further includes at least one more pixel marked as outside, each of said marked pixels being a different color.

12. The system of claim 9, in which the processor means masks each floor pixel by the one above such that the pixel below is interior and the pixel above is exterior, to mark it as a roof pixel.
